(19) United States
(12) Patent Application Publication
(10) Pub. No.: US 2008/0106398 A1
(43) Pub. Date: May 8, 2008

(54) Radio frequency identification connector

(75) Inventor: Bradley A. Rohlf, Lakeville, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/759,285

(22) Filed: Jun. 7, 2007

Related U.S. Application Data
(60) Provisional application No. 60/856,771, filed on Nov. 3, 2006.

(51) Int. Cl. G08B 1/08

(52) U.S. Cl. 340/532; 340/531; 340/539.1; 340/693.1

(57) ABSTRACT

A radio frequency identification connector connects a radio frequency identification device to an elongate member such as a safety cable.

This application claims the benefit of U.S. Provisional Application Ser. No. 60/856,771, filed Nov. 3, 2006.

### RELATED APPLICATIONS

This disclosure is related to the following co-pending applications: (1) Retrofittable Radio Frequency Identification Tag” by Brent J. Knoll et al., U.S. Provisional Application Ser. No. 60/811,965, filed Jun. 8, 2006; (2) “Radio Frequency Identification Tag” by Brent J. Knoll et al, U.S. patent application Ser. No. 29/249,952, filed Oct. 27, 2006; (3) “Retrofittable Radio Frequency Identification Connectors” by Brent J. Knoll et al., U.S. Provisional Application Ser. No. 60/856,607, filed Nov. 3, 2006; (4) “Radio Frequency Identification Connectors” by Bradley A. Rohlf, U.S. Provisional Application Ser. No. 60/856,771, filed Nov. 3, 2006; (5) “Connector for Radio Frequency Identification Device” by Bradley A. Rohlf, U.S. patent application Ser. No. 29/279,897, filed May 10, 2007; (6) “Retrofittable Radio Frequency Identification Connector” by Brent J. Knoll et al., Attorney Docket No. 221P182USU1, filed Jun. 7, 2007; (7) “Retrofittable Radio Frequency Identification Connector” by Bradley A. Rohlf, Attorney Docket No. 221P201USU1, filed Jun. 7, 2007; (8) “Retrofittable Radio Frequency Identification Connector” by Bradley A. Rohlf, Attorney Docket No; 221P202USU1, filed Jun. 7, 2007; (9) “Retrofittable Radio Frequency Identification Connector” by Bradley A. Rohlf et al., Attorney Docket No. 221P200US01, filed Jun. 7, 2007; and (10) “Radio Frequency Identification Connector” by Bradley A. Rohlf, Attorney Docket No. 221P203USU1, filed Jun. 7, 2007; which are not admitted as prior art with respect to the present disclosure by its mention in this section.

### FIELD OF THE INVENTION

The present invention relates to a radio frequency identification connector for connecting a radio frequency identification device to an elongate member such as a safety cable.

### BACKGROUND OF THE INVENTION

To comply with industry standards, safety devices used for fall protection and fall arrest purposes should be inspected by the user prior to each use and by a competent person other than the user at least annually. To demonstrate compliance with the industry standards, the results of the inspections should be recorded in an inspection and maintenance log for each safety device identified by the model number, the serial number, and the date manufactured or purchased. The inspection and maintenance log should also include information such as the date inspected, the inspection items noted, corrective action, maintenance performed, and the initials of the person who approved the inspection. Other information may also be included such as the dates of the next inspection and maintenance.

For example, some safety devices commonly include labels on which the inspection and maintenance log information may be recorded. However, these labels may become difficult to write on or read should they become soiled. If a separate inspection and maintenance log is kept, it may be difficult to locate the separate log and keep it current, especially if the log is kept in a different location than the safety devices. Therefore, it is desired to provide an inspection and maintenance log that is easily accessible and convenient to use.

The present invention addresses the problems associated with the prior art devices and provides for radio frequency identification connectors for connecting radio frequency identification devices to elongate members such as safety cables for use with inspection and maintenance logs that are easily accessible and convenient to use.

### SUMMARY OF THE INVENTION

One aspect of the present invention provides an identification device connector for connecting an identification device including an aperture to an elongate member comprising a connector member including a portion and a bore. The portion has a first end and a second end. The second end has a recessed portion. The bore extends longitudinally through the first end, the second end, and the recessed portion. The recessed portion is configured and arranged to receive the identification device with the aperture in fluid communication with the bore. The bore and the aperture are configured and arranged to receive the elongate member extending through the bore and the aperture.

Another aspect of the present invention provides an identification device connector assembly comprising an elongate member, an identification device including an aperture, and a connector including a portion and a bore. The portion has a first end and a second end. The second end has a recessed portion. The bore extends through the first end, the second end, and the recessed portion. The recessed portion is configured and arranged to receive the identification device with the aperture in fluid communication with the bore. The bore and the aperture are configured and arranged to receive the elongate member extending through the bore and the aperture.

Another aspect of the present invention provides a method of connecting an identification device to a safety cable comprising inserting an end of a cable through a bore of a connector, inserting the end of the cable through an aperture of an identification device, and inserting the identification device into a recessed portion of the connector, the aperture and the bore being aligned and in fluid communication.

### BRIEF DESCRIPTION OF THE DRAWINGS

FIG. 1 is a side view of a safety cable and a side partial cross-sectional view of a radio frequency identification connector revealing a radio frequency identification device contained therein operatively connected to the safety cable constructed according to the principles of the present invention;

FIG. 2 is a side cross-sectional view of the radio frequency identification connector shown in FIG. 1; and

FIG. 3 is a top view of the radio frequency identification connector shown in FIG. 1.

### DETAILED DESCRIPTION OF A PREFERRED EMBODIMENT

A preferred embodiment radio frequency identification connector constructed according to the principles of the present invention is designated by the numeral 100 in the drawings.

An example of a suitable radio frequency identification (“RFID”) device that may be used with the embodiments of the present invention is a 134.2 kilohertz half-duplex electronic ID by Allflex USA, Inc, in Dallas Fort Worth, Tex. Another example of a suitable RFID device is disclosed in U.S. Patent Application Publication No. US 2006/0117619 A1, which is incorporated herein by reference. Although the present invention is described herein as a connector for use with a RFID device, it is recognized that the connector may also be used with other suitable identification devices such as, but not limited to, bar codes, serial numbers, and metallic codes. These identification devices may be used individually or in any combination with the connector of the present invention.

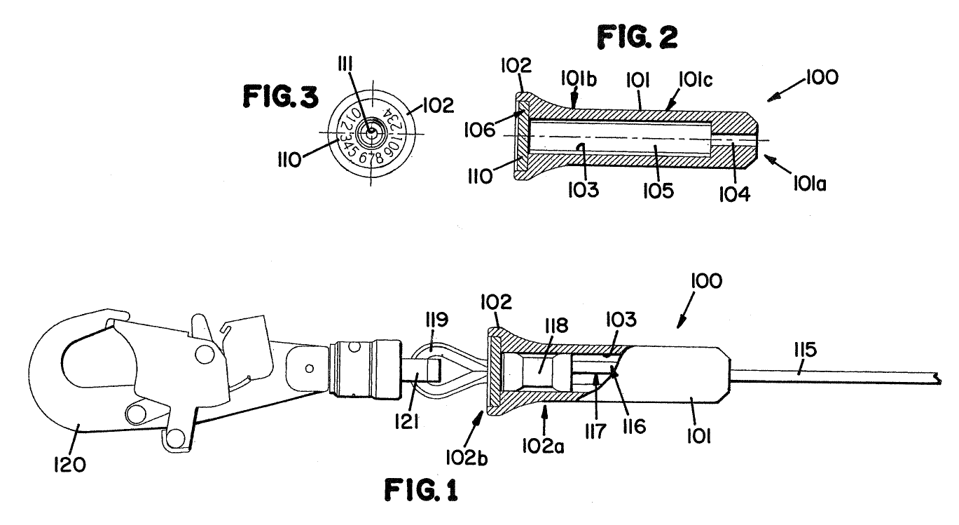

As shown in FIG. 1, the radio frequency identification connector 100 connects a radio frequency identification device 110 to a safety cable 115. Although a safety cable is described herein, any suitable elongate member may be used. The connector 100 is also a bumper that is configured and arranged to protect an end 117 of the safety cable 115 secured to an intermediate portion proximate the end 117 of the safety cable 115 with a fastener 118 as is well known in the art to form a loop 119 to which a hook 120 may be connected. An example of such a safety cable is a self-retracting lifeline including a wire rope, Model Number 3403400, by D B Industries, Inc. of Red Wing, Minn.

The connector 100 includes a base portion 101 operatively connected to a bumper portion 102 and a bore 103 extending longitudinally through the base portion 101 and the bumper portion 102, as shown in FIG. 2. The base portion 101 is cylindrical and includes a first end 101a, a second end 101b, and a middle portion 101c. The first end 101a preferably includes angled edges proximate the end of the connector 100. The bumper portion 102 includes a first end 102a, which is preferably frusto-conical, and a second end 102b, which is preferably cylindrical. The first end 102a of the bumper portion 102 is operatively connected to the second end 101b of the base portion 101 and then increases in diameter as it extends toward the second end 102b, which has a larger diameter than the base portion 101. The second end 102b includes a recessed portion 106 configured and arranged to accommodate a circular disk-shaped radio frequency identification device 110 with an aperture 111. Preferably, the radio frequency identification device 110 is friction fit within the recessed portion 106, as shown in FIG. 3, with the longitudinal axis of the radio frequency identification device 110 perpendicular to the longitudinal axis of the connector 100 so that the aperture 111 aligns with the bore 103. The base portion 101 and the bumper portion 102 are preferably made of urethane or any other suitable material molded as integral components, but it is recognized that these may be separate components operatively connected.

The bore 103 allows the safety cable 115 to extend through the connector 100. The bore 103 includes a narrow portion 104 and a wide portion 105, which are in fluid communication with one another and with the recessed portion 106. Proximate the juncture of the first end 101a and the middle 111c and extending through the first end 101a is the narrow portion 104 of the bore 103. Proximate the juncture of the first end 101a and the middle 101c and extending through the second end 101b and the bumper portion 102 is the wide portion 105 of the bore 103. The radio frequency identification device 110 fits within the recessed portion 106 so that the aperture 111 is in fluid communication with the wide portion 105 and the narrow portion 104. Thus, the safety cable 115 may extend through the bore 103 of the connector 100 and the aperture 111 of the radio frequency identification device 110.

To connect the radio frequency identification device 110 to the safety cable 115, the end 117 of the safety cable 115 is inserted through the bore 103 from the first end 101a and out the second end 102b so that the safety cable 115 extends through the connector 100. The end 117 of the safety cable 115 is then inserted through the aperture 111 of the device 110, through a connecting portion 121 of the hook 120, and then back through the aperture 111 of the device 110 thus forming a loop 119 connecting the safety cable 115 to the hook 120. The end 117 is then secured to a portion 116 proximate the end 117 of the safety cable 115 with a fastener 118 as is well known in the art. The connector 100 is then held in one hand while the safety cable 115 is held in the other hand proximate the first end 101a and pulled in a direction away from the connector 100. This pulls the portion 116, the end 117, and the fastener 118 into the wide portion 105 of the bore 103, and the narrow portion 104 of the bore 103 is configured and arranged to accommodate the safety cable 115 extending outward from proximate the fastener 118 and out of the connector 100. If the device 110 was not pulled into the recessed portion 106 as the safety cable 115 was pulled, the device 110 may be separately positioned into the recessed portion 106. The loop 119 extends through the aperture 111 of the radio frequency identification device 110, which is positioned within the recessed portion 106 of the bore 103, and extends outward from the connector 100. Once the connector is connected to the safety device, the connector can be located and the identifying information of the connector can be scanned. The identifying information of the connector is linked to data stored in a computer database where the inspection and maintenance log information can be entered and saved for the safety device. Examples of how this can be accomplished are disclosed in the following co-pending applications, the entire contents of which are hereby incorporated by reference in their entirety: (1) “Method of Facilitating Controlled Flow of Information for Safety Equipment Items and Database Related Thereto” by Dean R. Kaartinen et al., U.S. patent application Ser. No. 11/759,148, filed Jun. 6, 2007; (2) “Direct Data Input For Database For Safety Equipment Items and Method” by Dean R. Kaartinen et al., U.S. patent application Ser. No. 11/759,152, filed Jun. 6, 2007; and (3) “Centralized Database of Information Related to Inspection of Safety Equipment Items Inspection and Method” by Dean R. Kaartinen et al., U.S. patent application Ser. No. 11/759,175, filed Jun. 6, 2007. The scanning of the identifying information of the connector makes recordation of the inspection and maintenance log information in the computer database easy because the connector is easily accessible and convenient to use regardless if the safety device is soiled.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An identification device connector for connecting an identification device including an aperture to an elongate member, comprising:
a) a connector member including a portion and a bore, the portion having a first end and a second end, the second end having a recessed portion, the bore extending longitudinally through the first end, the second end, and the recessed portion, the recessed portion being configured and arranged to receive the identification device with the aperture in fluid communication with the bore, the bore and the aperture configured and arranged to receive the elongate member extending through the bore and the aperture.

2. The connector of claim 1, wherein the portion includes a base portion proximate the first end and a bumper portion proximate the second end, the bumper portion having a larger diameter than the base portion and including the recessed portion.

3. The connector of claim 2, wherein the bore has a larger diameter within the bumper portion than within the base portion.

4. The connector of claim 3, wherein the recessed portion has a larger diameter than the bore within the bumper portion.

5. An identification device connector assembly, comprising:
a) an elongate member;
b) an identification device including an aperture; and
c) a connector including a portion and a bore, the portion having a first end and a second end, the second end having a recessed portion, the bore extending through the first end, the second end, and the recessed portion, the recessed portion being configured and arranged to receive the identification device with the aperture in fluid communication with the bore, the bore and the aperture configured and arranged to receive the elongate member extending through the bore and the aperture.

6. The assembly of claim 5, wherein the elongate member is a safety cable having an end secured to an intermediate portion of the safety cable proximate the end to form a loop.

7. The assembly of claim 6, wherein the safety cable is wire rope.

8. The assembly of claim 6, wherein the portion includes a base portion proximate the first end and a bumper portion proximate the second end, the bumper portion having a larger diameter than the base portion and including the recessed portion.

9. The assembly of claim 8, wherein the bore has a larger diameter within the bumper portion than within the base portion and the bore is configured and arranged to accommodate the end secured to the intermediate portion of the safety cable within the bumper portion.

10. The assembly of claim 8, wherein the connector is a cable bumper.

11. The assembly of claim 8, wherein the safety cable is operatively connected to a self-retracting lifeline.

12. The assembly of claim 8, wherein the identification device is a circular disk-shape with the aperture extending through a center of the circular disk-shape.

13. The assembly of claim 5, wherein the identification device is friction fit within the recessed portion.

14. The assembly of claim 5, wherein the identification device is a radio frequency identification device.

15. A method of connecting an identification device to a safety cable, comprising.
a) inserting an end of a cable through a bore of a connector,
b) inserting the end of the cable through an aperture of an identification device; and
c) inserting the identification device into a recessed portion of the connector, the aperture and the bore being aligned and in fluid communication.

16. The method of claim 15, wherein the cable is inserted into a first end of the connector, through the bore, and out of a second end of the connector, the second end of the connector including the recessed portion.

17. The method of claim 15, wherein the cable is inserted through the aperture in the identification device, through a first end of the connector, through the bore, and out of a second end of the connector, the first end of the connector including the recessed portion.
